(19) United States
(12) Patent Application Publication
(10) Pub. No.: US 2008/0272870 A1
(43) Pub. Date: Nov. 6, 2008

(54) ELECTROMAGNETIC ACTUATOR

(75) Inventor: Hideaki Miyamoto, Ogaki-shi (JP)

Correspondence Address: DITTHAVONG MORI & STEINER, P.C., 918 Prince St., Alexandria, VA, 22314, US

(73) Assignee: Sanyo Electric Co., Ltd., Moriguchi-shi (JP)

(21) Appl. No.: 12/110,038

(22) Filed: Apr. 25, 2008

(30) Foreign Application Priority Data
Apr. 27, 2007 (JP) 2007-117998

(51) Int. Cl. H01F 7/08

(52) U.S. Cl. 335/229

(57) ABSTRACT

An electromagnetic actuator is provided with a stationary portion including first and second positions. First electric wires are arranged at the first and second position of the stationary portion. A movable portion is movable between the first and second positions and includes a magnetic pole surface having a magnetic pole. The magnetic pole surface faces toward a corresponding one of the first electric wires when the movable portion is located at the first position or the second position. A drive circuit moves the movable portion. The electromagnetic actuator uses electromagnetic induction that occurs due to each of the first electric wires and the magnetic pole to detect the position of the movable portion. When trying to move the movable portion to the first position, the drive circuit temporarily applies force to the movable portion to first move the movable portion toward the second position.

### CROSS-REFERENCE TO RELATED APPLICATIONS

This application is based upon and claims the benefit of priority from prior Japanese Patent Application No. 2007-117998, filed on Apr. 27, 2007, the entire contents of which are incorporated herein by reference.

### BACKGROUND OF THE INVENTION

The present invention relates to an electromagnetic actuator, and more particularly, to an electromagnetic actuator for moving a movable portion across a light path.

An optical pickup module is one example of a device that includes an actuator for moving a movable portion that is located along a light path. A typical pickup module includes components that are moved by an actuator. Such components include an objective lens, a collimator lens, a light-reducing filter (a neutral density filter), and a light path switching mirror. Nowadays, an optical pickup module must record and reproduce data for a wide variety of optical discs, such as a CD, a DVD, a HD (high-definition) disc, and a BD (Blu-ray) disc. This increases the number of components in an optical pickup module and enlarges the optical pickup module. Nevertheless, an optical pickup module may be installed in a portable DVD player or a mobile personal computer and thus must be reduced in size.

One example of a prior art actuator for an optical pickup module is an electrostatic actuator that uses the electrostatic force of an electret (refer to Japanese Laid-Open Patent Publication No. 2005-99208).

The electrostatic actuator described in the above publication includes a first light transparent member, a second light transparent member, and a third light transparent member. A first film, which shields out infrared light, is arranged between the first and second light transparent members. A second film, which reduces the transmitted amount of visible light, is arranged between the second and third light transparent members. The first and second films each include a plurality of electret portions. The first and second light transparent members each have an electrode surface including a plurality of electrodes. The electrode surface of the first light transparent member and the electrode surface of the second light transparent member are respectively faced toward the electret portions of the first and second films. In the above electret actuator, electrostatic force is generated between the electrodes of the first and second light transparent portions and the electret portions of the first and second films to move the first and second films.

In the actuator of the prior art described above, the position of each film is detected to ensure that the first and second films have each moved to a predetermined position. In the prior art, for such detection, an actuator normally uses mechanical components such as mechanical switches that are mechanically operated when the first or second film moves. Accordingly, it is required that the number of components of the actuator be prevented from being increased to avoid enlargement of the actuator.

### SUMMARY OF THE INVENTION

One aspect of the present invention is an electromagnetic actuator including a stationary portion on which a first position and a second position are defined. A plurality of first electric wires are arranged on the stationary portion at the first position and the second position. A movable portion is movable between the first position and the second position and includes a magnetic pole surface having a magnetic pole. The magnetic pole surface faces toward a corresponding one of the first electric wires when the movable portion is located at the first position or the second position. A drive circuit moves the movable portion. The electromagnetic actuator uses electromagnetic induction that occurs due to each of the first electric wires and the magnetic pole to detect the position of the movable portion. When trying to move the movable portion to the first position, the drive circuit temporarily applies force to the movable portion to move the movable portion toward the second position.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram of an optical pickup module according to a preferred embodiment of the present invention;

FIG. 2 is a cross-sectional view showing the layout of a semiconductor laser source and a light-reducing filter actuator that are included in the optical pickup module of FIG. 1;

FIG. 3 is a perspective view showing the light-reducing filter actuator of FIG. 2;

FIG. 4 is a cross-sectional view taken along line 700-700 in FIG. 3; and

FIGS. 5 to 8 are cross-sectional views showing the operation of the light-reducing filter actuator in the preferred embodiment of the present invention.

### DETAILED DESCRIPTION OF THE PREFERRED EMBODIMENTS

A preferred embodiment of the present invention will now be discussed with reference to the drawings. To avoid redundancy, like or same reference numerals are given to those components that are the same or similar in all of the drawings.

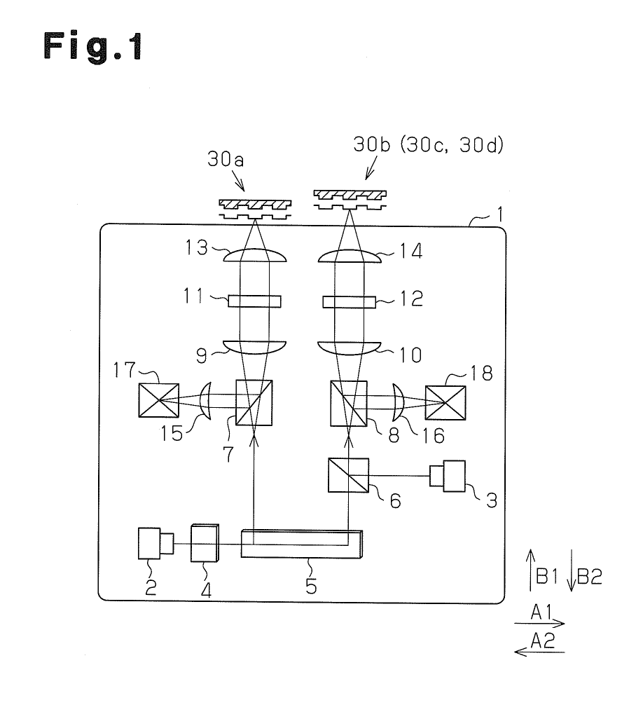

Referring to FIG. 1, a optical pickup module 1 according to the preferred embodiment includes light source (semiconductor laser sources) 2 and 3, a light-reducing filter 4, a light path switching unit 5, a dichroic beam splitter 6, polarization beam splitters 7 and 8, collimator lenses 9 and 10, ¼ wavelength plates 11 and 12, objective lenses 13 and 14, light receiving lenses 15 and 16, and light receiving sensors 17 and 18. The optical pickup module 1 is configured to write data to and read data from an optical disc 30a, which is in compliance with the BD (Blu-ray Disc) standard, and an optical disc 30b (30c and 30d), which is in compliance with the HD DVD standard (CD standard and DVD standard).

The semiconductor laser source 2 emits a blue-violet laser beam having a wavelength of about 405 nm. The semiconductor laser source 2 emits laser beam when writing data to or reading data from the optical disc 30a of the BD standard or the optical disc 30b of the HD DVD standard.

The semiconductor laser source 3 emits laser beams of two wavelengths, red laser beam having a wavelength of about 650 nm and near infrared laser beam having a wavelength of about 785 nm. The semiconductor laser source 3 is controlled to emit the laser beam having the wavelength of about 785 nm when writing data to or reading data from the optical disc 30c of the CD standard. Further, the semiconductor laser source 3 is controlled to emit laser beam having the wavelength of about 650 nm when writing data to or reading data from the optical disc 30d of the DVD standard.

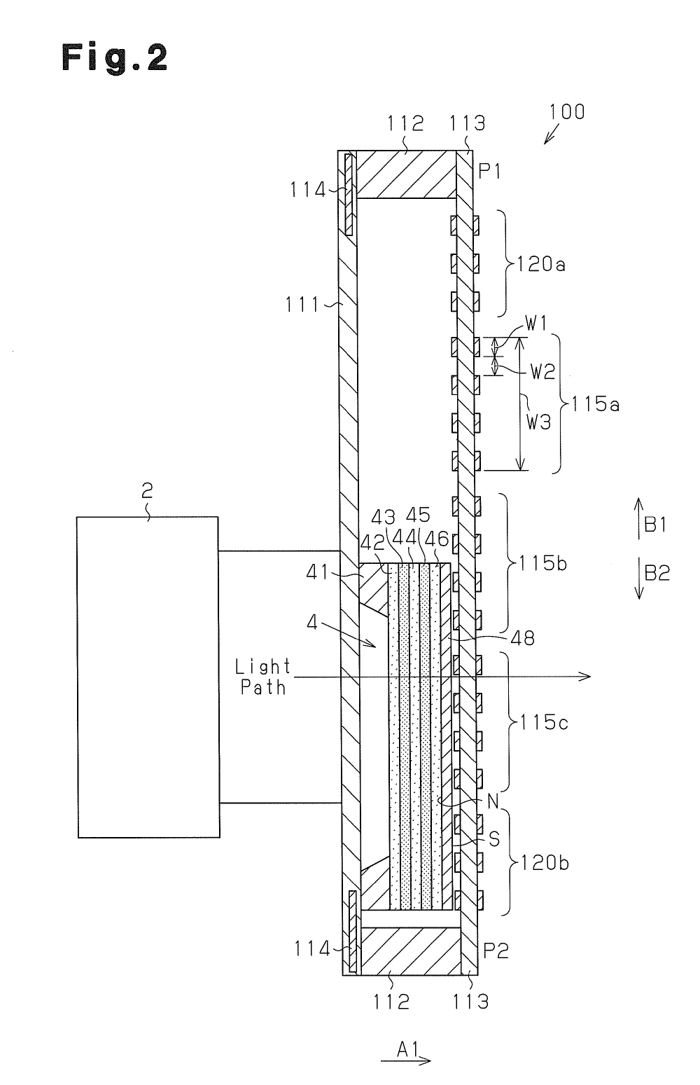

The light-reducing filter 4 is movably supported by a light-reducing filter actuator 100 (refer to FIG. 2). The light-reducing filter actuator 100 moves the light-reducing filter 4 between two positions (a position located in the light path and a position separated from the light path) along a direction perpendicular to the optical axis of the laser beam, i.e., direction of arrows B1 and B2, hereinafter referred to as the B1 direction and the B2 direction.

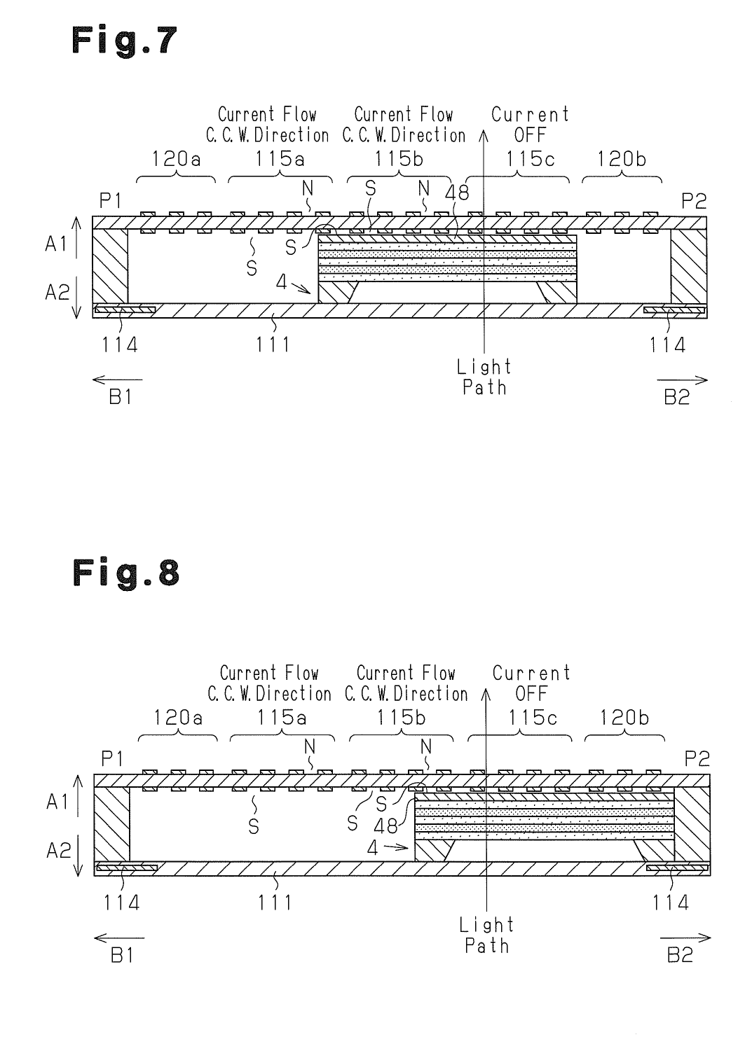

The light-reducing filter 4 is arranged at a position located in the light path when reading data from an optical disc and arranged at a position separated from the light path when writing data to the optical disc. Accordingly, the light-reducing filter 4 is used to lower the intensity of the laser beam emitted from the semiconductor laser source 2 only when reading data. A position located in the light path refers to a state in which the light-reducing filter 4 is moved in the B2 direction (for example, a state in which the light-reducing filter 4 is located toward the P2 side as shown in FIG. 8). A position separated from the light path refers to a state in which the light-reducing filter 4 is moved in the B1 direction (for example, a state in which the light-reducing filter 4 is located toward the P1 side as shown in FIG. 5).

The light path switching unit 5 includes an internal movable mirror (not shown). The light path switching unit 5 moves the movable mirror so that the laser beam emitted from the semiconductor laser source 2 selectively enters one of the objective lenses 13 and 14.

The dichroic beam splitter 6 transmits the laser beam emitted from the semiconductor laser source 2 and reflects the laser beam emitted from the semiconductor laser source 3. Thus, the laser beam emitted from the semiconductor laser source 2 is transmitted through the dichroic beam splitter 6 to enter the objective lens 14. Further, the laser beam emitted from the semiconductor laser source 3 is reflected by the dichroic beam splitter 6 to enter the objective lens 14.

The polarization beam splitters 7 and 8 respectively transmit laser beams directed towards the optical discs 30a and 30b (30c and 30d) in the B1 direction. Further, the laser beams returning from the optical discs 30a and 30b (30c and 30d) in the B2 direction are reflected by the polarization beam splitters 7 and 8 in the directions indicated by arrows A2 and A1 (hereinafter referred to as the A2 direction and the A1 direction), respectively.

The collimator lenses 9 and 10 respectively move along the optical axes (in the B1 and B2 directions) and convert the laser beams received from the beam splitters 7 and 8 to collimated lights having predetermined beam diameters. Further, the collimator lenses 9 and 10 respectively adjust the focal positions of the laser beams directed toward the polarization beam splitters 7 and 8.

The ¼ wavelength plates 11 and 12 respectively convert the laser beams directed in the B1 direction towards the optical discs 30a and 30b (30c and 30d) from linear polarization to circular polarization. Further, the ¼ wavelength plates 11 and 12 respectively convert the laser beams returning in the B2 direction from the optical discs 30a and 30b (30c and 30d) to linear polarization, which includes a magnetic field that oscillates in a direction perpendicular to an oscillation direction of a magnetic field for the laser beams directed towards the optical discs 30a and 30b (30c and 30d) in the B1 direction.

The objective lenses 13 and 14 are movable along the optical axes (B1 and B2 directions) and in a direction perpendicular to the optical axes (A1 and A2 directions). The objective lenses 13 and 14 adjust the focal position of the laser beams.

The light receiving lenses 15 and 16 respectively focus the laser beam reflected by the polarization beam splitters 7 and 8 on the light receiving sensors 17 and 18.

The structure of the light-reducing filter actuator 100 will now be discussed with reference to FIGS. 2 to 4.

Referring to FIG. 2, the light-reducing filter actuator 100 moves the light-reducing filter 4 across the light path of the laser beam emitted from the semiconductor laser source 2. In the illustrated example, the light-reducing filter 4 is moved in directions (B1 and B2 directions) that are perpendicular to the optical axis (A1 direction) of the laser beam emitted from the semiconductor laser source 2. The light-reducing filter 4 may be moved in a direction deviated from a direction perpendicular to the optical axis (A1 direction) of the laser beam. For example, the light-reducing filter 4 may be moved in a direction that is inclined relative to the A1 direction. In such a case, the laser beam reflected by the light-reducing filter 4 is prevented from entering the light source, or the semiconductor laser source 2.

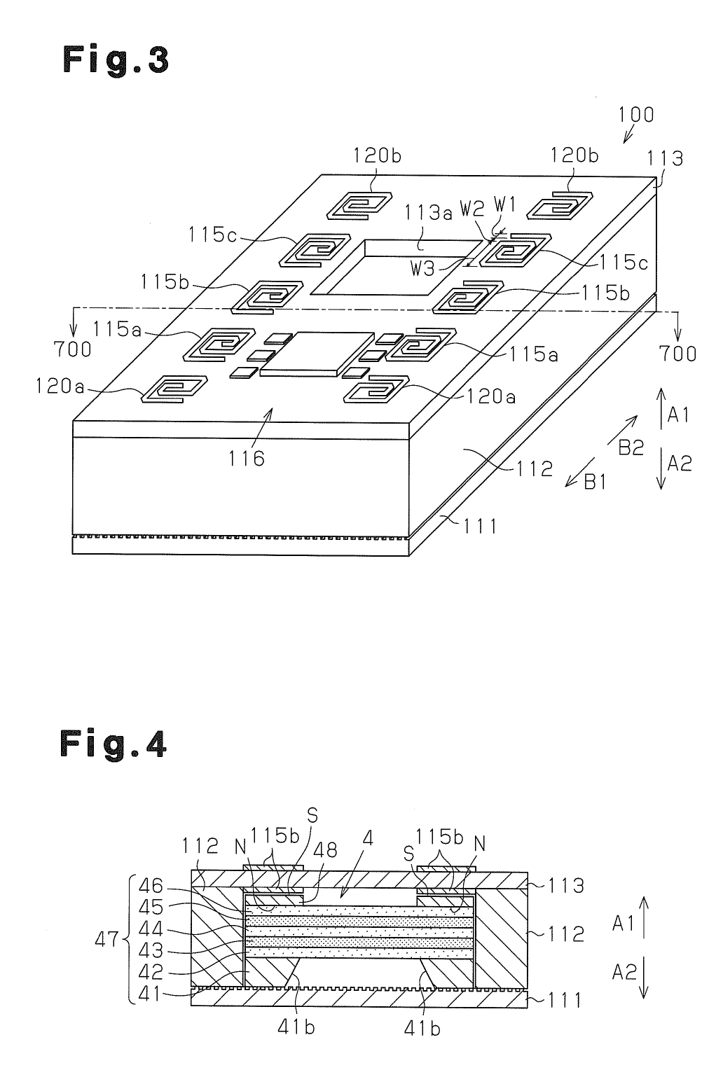

Referring to FIG. 3, the light-reducing filter actuator 100 includes a resin plate-shaped support 111, a resin wall 112, a plate-shaped support 113, and the light-reducing filter 4. The wall 112 surrounds the edges of the support 111. The support 113 is spaced from the support 111 by a predetermined distance and may be a printed circuit board. The light-reducing filter 4 is arranged between the supports 111 and 113.

The support 113 includes an opening 113a, which faces toward an opening (not shown) in the support 111. Thus, the opening 113a is aligned with the opening of the support 111 in the direction of a normal line (A1 and A2 directions). The opening of the support 111 and the opening 113a are each small enough to prevent passage of the light-reducing filter 4 and larger than the beam diameter of the laser beam.

As shown in FIG. 3, the opening 113a is arranged between two coil lines on the support 113. Each coil line includes coils 115a to 115c, which function as drive electric wires for moving the light-reducing filter 4, and two coils 120a and 120b, which function as position detection electric wires for detecting the position of the light-reducing filter 4. The coils 115a to 115c and the coils 120a and 120b are straightly laid out in each coil line. The coil 120a is arranged at one end of each coil line, and the coil 120b is arranged at the other end of each coil line. The number of the drive electric wires is not limited to three, and there may be any number of drive electric wires as long as there are at least two. In addition to the support 113, the drive electric wires (coils 115a to 115c) and the position detection electric wires (coils 120a and 120b) may also be laid out on the support 111.

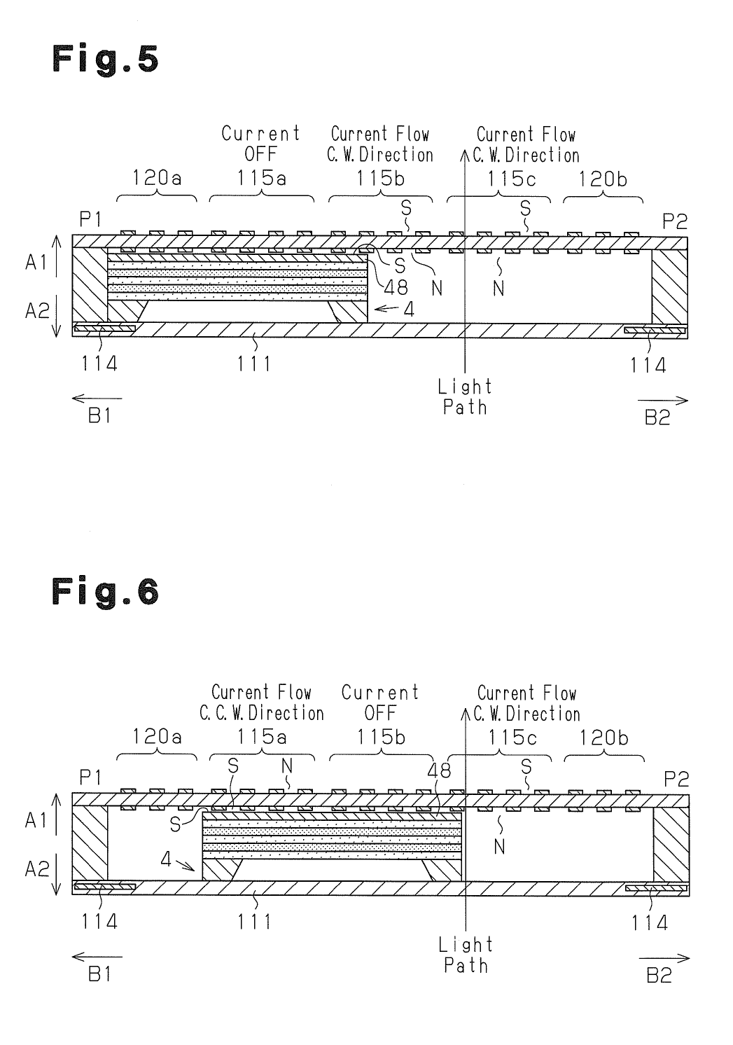

The coils 115a to 115c are planar coils made of copper and have a thickness of 20 μm. The copper wire forming each of the coils 115a to 115c has a width W1 (refer to FIG. 2) and is laid out to be spaced from the next winding by distance W2. The width W1 and the distance W2 are both approximately 25 μm. The coil 115b may be formed by two electrically connected planar coils (dual layer planar coil) arranged on the upper and lower surfaces of the support 113 as viewed in FIG. 4. The same applies for coils 115a and 115c. The use of planar coils reduces the thickness of the coils 115a to 115c. The stacking of two layers in a planar coil decreases the coil current required to obtain the predetermined driving force. This also reduces the area occupied by the coil.

In the same manner as the coils 115a to 115c, the coils 120a and 120b may also be planar coils with dual layers. The coils 120a and 120b are only required to cause electromagnetic induction with a magnet in order to generate induced electromotive force. The number of windings in each of the coils 120a and 120b may be less than that of each of the coils 115a to 115c. Further, the area occupied by each of the coils 120a and 120b may be less than that occupied by each of the coils 115a to 115c.

The support 111 has a surface that comes into contact with the light-reducing filter 4. This surface includes fine pits (refer to FIGS. 3 and 4). The fine pits reduce the area of contact between the light-reducing filter 4 and the support 111 and decrease the friction coefficient between the light-reducing filter 4 and the support 111. This lowers the power required to move the light-reducing filter 4. Further, as shown in FIG. 2, magnetic bodies 114 are embedded in the support 111. The magnetic bodies 114 each magnetically attract neodymium boron magnets 48 to magnetically hold the light-reducing filter 4. The magnetic bodies 114 may be exposed from the support 111 or may be arranged in the support 111. Further, the magnetic bodies 114 may be arranged in the wall 112 or the support 113.

As shown in FIG. 3, an IC 116, which functions as a drive circuit, is arranged on the support 113. The IC 116 includes a control circuit for controlling the current supplied to the coils 115a to 115c and a detection circuit for detecting the induced electromotive force generated by the coils 120a and 120b. The arrangement of the IC 116 on the support 113 shortens the length of the wiring between the coils 115a to 115c and the IC 116 and prevents increases in the power consumption of the light-reducing filter actuator 100.

As shown in FIG. 4, the light-reducing filter 4 includes a silicon substrate 41, which has an opening 41b, and a laser beam absorption portion 47, which is superimposed on the silicon substrate 41. The passage of laser beam through the opening 41b and the laser beam absorption portion 47 lowers the intensity of the laser beam. The laser beam absorption portion 47 includes, for example, a silicon oxide film 42, a silicon nitride film 43, a polysilicon film 44, a silicon nitride film 45, and a silicon oxide film 46. In the laser beam absorption portion 47, the silicon oxide film 42, the polysilicon film 44, and the silicon oxide film 46 function as light absorption layers, each of which absorbs laser beam. The laser absorption portion may be formed from glasses including light absorption materials such as potassium, tin, iron, aluminum, sodium, and carbon. Two neodymium boron magnets 48 are fixed to the silicon oxide film 46. Each neodymium boron magnet 48 is, for example, a square plate (rectangular plate) having a main surface (magnetic pole surface), which faces toward the support 113, and a rear surface, which is opposite the main surface. The magnetizing direction of each neodymium boron magnet 48 is the same as the normal line direction (A1 direction) relative to the main surface of the neodymium boron magnet 48. For example, the main surface of the neodymium boron magnet 48 may be the south (S) pole. When the neodymium boron magnets 48 face toward the coils 115b, a predetermined clearance is formed between the main surface of each neodymium boron magnet 48 and the corresponding coil 115b. The same applies for the coils 115a and 115c. The coils 115a to 115c are each laid out to have a width W3 (refer to FIG. 2). The light-reducing filter 4 has a length in the longitudinal direction (B1 and B2 directions) of the neodymium boron magnets 48 that is adjusted to be approximately 2.2 times greater than the width W3 of the coils 115a to 115c. The illustrated light-reducing filter 4 includes the silicon substrate 41, the laser beam absorption portion 47, and the neodymium boron magnets 48.

The support 113 serves as an example of a “stationary portion” in the present invention. The light-reducing filter 4 serves as an example of a “movable portion” in the present invention. The coils 120a and 120b each serve as an example of a “first electric wire” in the present invention. The position of the coil 120b (P2 side) serves as a “first position” in the present invention. The position of the coil 120a (P1 side) serves as an example of a “second position” in the present invention. Further, the coils 115a to 115c each serve as an example of a “second electric wire” in the present invention.

The operation of the light-reducing filter actuator 100 will now be discussed with reference to FIGS. 5 to 8.

In the following description, the direction of the current flowing through each coil is based on a view from the upper side of FIG. 5.

FIG. 5 shows a state in which the light-reducing filter 4 is located toward the B1 direction (adjacent to the P1, or immediately below the coil 120a). When moving the light-reducing filter 4 in the B2 direction toward the P2 side, current is supplied to the coils 115b and 115c to flow in a clockwise (CW) direction, and current is not supplied to the coils 115a. In this state, each of the coils 115b and 115c generate a magnetic field that is directed in the A1 direction from the north (N) pole to the south (S) pole. Further, the coils 115a do not generate a magnetic field. Thus, a magnetic attraction force acts between the S poles of the neodymium boron magnets 48 and the N poles of the coils 115b. Additionally, a magnetic attraction force acts between the S poles of the neodymium boron magnets 48 and the N poles of the coils 115c. This moves the light-reducing filter 4 in the B2 direction.

FIG. 6 shows a state in which the light-reducing filter 4 is moved away from the coils 120a of the light-reducing filter actuator 100. In this state, the light-reducing filter 4 is not located immediately below the coil 120a. When the light-reducing filter 4 moves from the position shown in the state of FIG. 5 and reaches the position shown in the state of FIG. 6, the IC 116 supplies the coils 115a with current flowing in the counterclockwise (CCW) direction, does not supply the coils 115b with current, and supplies the coils 115a with current flowing the clockwise direction. In this state, the coils 115a each generate a magnetic field that is directed in the A2 direction from the N pole to the S pole. The coils 115b do not generate a magnetic field. Further, the coils 115c each generate a magnetic field that is directed in the A1 direction from the N pole to the S pole. Thus, a magnetic repulsion force acts between the S poles of the neodymium boron magnets 48 and the S poles of the coils 115c, and a magnetic attraction force acts between the S poles of the neodymium boron magnets 48 and the N poles of the coils 115c. This further moves the light-reducing filter 4 in the B2 direction.

As shown in the state of FIG. 7, when the light-reducing filter 4 is about to reach a position immediately below the coil 120b, the IC 116 supplies the coils 115a and 115b with current flowing in the counterclockwise direction but does not supply the coils 115c with current. As a result, the coils 115a and 115b each generate a magnetic field that is directed in the A2 direction from the N pole to the S pole. Thus, a repulsion force acts between the S poles of the neodymium boron magnets 48 and the S poles of the coils 115a and 115b. This further moves the light-reducing filter 4 in the B2 direction. Consequently, as shown in the state of FIG. 8, the light-reducing filter 4 reaches a position located toward the B2 direction of the light-reducing filter actuator 100 (adjacent to the P2, or immediately below the coil 120b).

The magnetic bodies 114 are embedded in the outer end portions of the support 111. In the states shown in FIGS. 5 and 8 in which the light-reducing filter 4 is located toward the B1 or B2 direction, for example located immediately below the coils 120a or 120b, the magnetic bodies 114 are attracted to the corresponding neodymium boron magnets 48. Thus, the light-reducing filter 4 is held in position even in a state in which current does not flow to the coils 115a to 115c.

A method for controlling current to move the light-reducing filter 4 will now be discussed.

In this embodiment, the position detection coils (coils 120a and 120b) are arranged at opposite end portions of each set of linearly arranged drive coils (coils 115a to 115c). When moving the light-reducing filter 4 to a position immediately below the coils 120a, electromagnetic induction (Faraday's law of induction) between the coils 120a and the S poles of the neodymium boron magnets 48 generate induced electromotive force in the coils 120a. The IC 116 may detect or monitor the induced electromotive force to determine whether or not the light-reducing filter 4 is located immediately below the coils 120a. The same applies for the coils 120b.

When the light-reducing filter 4 moves away from a position immediately below the coils 120a, an induced electromotive force that is opposite the above-described induced electromotive force is generated in the coils 120a. The opposite induced electromotive force may be detected or monitored to determine whether or not the light-reducing filter 4 has moved away from a position immediately below the coils 120a. The same applies for the coils 120b.

In this manner, the induced electromotive force generated by the coils 120a or the coils 120b may be detected or monitored when switching the direction in which current flows to the coils 115a to 115c, which are shown in FIGS. 5 to 8, in accordance with the position of the light-reducing filter 4.

The operation for moving the light-reducing filter 4 from a position located toward the B1 direction (immediately below the coils 120a at the P1 side) of the light-reducing filter actuator 100 to a position located toward the B2 direction (P2 side) is discussed above. When a strong external force is applied to the light-reducing filter actuator 100, the light-reducing filter 4 may be moved away from its predetermined position such that the position of the light-reducing filter 4 becomes unknown. In a state in which the light-reducing filter 4 is located toward the B2 direction (immediately below the coils 120b at the P2 side) of the light-reducing filter actuator 100 and the drive coils are supplied with current to further move the light-reducing filter 4 in the B2 direction, the position of the light-reducing filter 4 cannot be detected from the induced electromotive force of the coils 120b since the light-reducing filter 4 is already located immediately below the coils 120b. Thus, it cannot be determined whether the light-reducing filter 4 is located toward the B2 direction (immediately below the coils 120b at the P2 side) or whether the light-reducing filter 4 cannot move due to an operation failure or the like. Accordingly, in the present embodiment, when trying to move the light-reducing filter 4 toward the B2 direction (P2 side), the drive coils (coils 115a to 115c) are temporarily supplied with current to first move the light-reducing filter 4 toward the B1 direction (P1 side) regardless of where the light-reducing filter 4 is initially located. Afterwards, the drive coils (coils 115a to 115c) are supplied with current to move the light-reducing filter 4 toward the B2 direction (P2 side).

More specifically, the sequences (steps 1 and 2) described below are carried out before supplying current that moves the light-reducing filter 4 from a position located toward the B1 direction (immediately below the coils 120a at the P1 side) to a position in the B2 direction (P2 side).

First, in step 1, the IC 116 supplies the coils 115a and 115b with current that flows in the clockwise direction but does not supply the coils 115c with current. As a result, the coils 115a and 115b each generate a magnetic field directed from the N pole toward the S pole in the A1 direction. The coils 115c do not generate magnetic fields. Thus, an attraction force acts between the S poles of the neodymium boron magnets 48 and the N poles of the coils 115a and 115b. The attraction force moves the light-reducing filter 4 to a location immediately below the coils 115a and 115b regardless of where the light-reducing filter 4 is initially located.

Next, in step 2, the IC 116 supplies the coils 115b and 115c with current that flows in the counterclockwise direction but does not supply the coils 115a with current. As a result, the coils 115b and 115a each generate a magnetic field directed from the N pole toward the S pole in the A2 direction. The coils 115a do not generate magnetic fields. Thus, a repulsion force acts between the S poles of the neodymium boron magnets 48 and the S poles of the coils 115b and 115c. The repulsion force ensures movement of the light-reducing filter 4 to a position toward the B1 direction (immediately below the coils 120a at the P1 side) of the light-reducing filter actuator 100.

After performing these sequences, the drive coils may be supplied with current to move the light-reducing filter 4 toward the B2 direction (P2 side) and generate induced electromotive force at the coils 120b regardless of the where the light-reducing filter 4 is initially located (for example, a state in which the light-reducing filter 4 is located immediately below the coils 120b at the P2 side of the light-reducing filter actuator 100) as long as the drive circuit for the light-reducing filter 4 is functioning normally. Further, detection of the position of the light-reducing filter 4 when moved toward the B2 direction (immediately below the coils 120b at the P2 side) based on the induced electromotive force of the coils 120b is ensured. Additionally, (A) movement of the light-reducing filter 4 can easily be ensured, (B) a control for performing a retry when the light-reducing filter 4 does not move even though the drive coils are supplied with current is facilitated, (C) and a control for outputting an error message and stopping processing when the light-reducing filter 4 does not move even though a retry is performed is facilitated.

The electromagnetic actuator (light-reducing filter actuator 100) of the present embodiment and an optical pickup module incorporating the electromagnetic actuator has the advantages described below.

(1) The IC 116 detects the induced electromotive force generated by the coils 120a to 120b to detect the position of the light-reducing filter at the P1 side (position immediately below the coils 120a) or the P2 side (position immediately below the coils 120b) of the light-reducing filter actuator 100. Separate mechanical components for detecting the position of the light-reducing filter 4 are not necessary. This avoids enlargement of the light-reducing filter actuator 100.

(2) When trying to move the light-reducing filter 4 to a position immediately below the coils 120b at the P2 side, the IC 116 supplies the drive coils with current to first move the light-reducing filter 4 in the B1 direction (P1 side) and then move the light-reducing filter 4 in the B2 direction (P2 side). The control of current in such a manner generates induced electromotive force at the coils 120b as long as the drive circuit for the light-reducing filter 4 is functioning normally. Detection of the light-reducing filter 4 when moved to a position immediately below the coils 120b at the P2 side is ensured by using induced electromotive force. In addition to avoiding enlargement of the light-reducing filter actuator 100, this improves the operational reliability of the light-reducing filter actuator 100.

(3) Even if the light-reducing filter 4 is initially located toward the B2 direction (immediately below the coils 120b at the P2 side) of the light-reducing filter actuator 100, the control of current in the above manner ensures detection of the light-reducing filter 4 when reaching the position located immediately below the coils 120b at the P2 side. In addition to avoiding enlargement of the light-reducing filter actuator 100, this improves the operational reliability of the light-reducing filter actuator 100.

(4) The attraction force or repulsion force that acts between the magnetic fields generated by the coils 115a to 115c and the neodymium boron magnets 48 moves the light-reducing filter 4 along the lines of the coils 115a to 115c. The direction in which current flows to the coils 115a to 115c may simply be changed to change the direction of the magnetic fields generated by the coils 115a to 115c. Thus, the control for changing the moving direction of the light-reducing filter 4 is simple.

(5) The support 113 includes the coils 115a to 115c, which are laid out on the surface facing toward the light-reducing filter 4 to function as electromagnets. Further, the light-reducing filter 4 includes the neodymium boron magnets 48 laid out on the surface facing toward the support 113. When supplying the coils 115a to 115c with current, an attraction force or repulsion force acts between the coils 115a to 115c and the neodymium boron magnets 48 to move the light-reducing filter 4. Such magnetic movement differs from the electrostatic movement of the prior art in that the voltage applied to the coils 115a to 115c does not have to be boosted. This enables the light-reducing filter actuator 100 to be more compact than an electrostatic actuator, which requires a booster circuit, since the light-reducing filter actuator 100 does not require a booster circuit. In this manner, enlargement of the light-reducing filter actuator 100 is avoided.

(6) The light-reducing filter actuator 100 ensures detection of the position of the light-reducing filter 4. The use of the light-reducing filter actuator 100 improves the operational reliability of the optical pickup module 1.

(7) The present embodiment can avoid enlargement of the light-reducing filter actuator 100. Thus, enlargement of the optical pickup module 1 can be avoided by using the light-reducing filter actuator 100.

It should be apparent to those skilled in the art that the present invention may be embodied in many other specific forms without departing from the spirit or scope of the invention. Particularly, it should be understood that the present invention may be embodied in the following forms.

In the above embodiment, drive coils are laid out on a support. However, the present invention is not limited in such a manner. For example, electric wires may be used in lieu of the drive coils. This would obtain the same advantages as the above embodiment.

The above embodiment uses neodymium boron magnets 48. However, the present invention is not limited in such a manner. For example, magnetic material or electric wires may be used in lieu of the neodymium boron magnets 48. This would obtain the same advantages as the above embodiment.

The above embodiment uses dual layer planar coils as the drive coils. However, the present invention is not limited in such a manner. For example, a planar coil having a single layer or a planar coil having three or more layers may be used as the drive coils. This would obtain the same advantages as the above embodiment.

In the above embodiment, laser beam enters the light-reducing filter surface in the normal line direction. However, the present invention is not limited in such a manner. For example, laser beam may be inclined at an angle when entering the light-reducing filter surface. This would reduce fluctuations in the light intensity of the light source caused by laser beam reflection of the light-reducing filter.

In the above embodiment, each neodymium boron magnet includes a surface facing toward the drive coils and having an S pole polarity. However, the present invention is not limited in such a manner. For example, the surface of the neodymium boron magnet facing toward the drive coils may have an N pole polarity. In such a case, the current supplied to the drive currents may be changed in accordance with the polarity of the neodymium boron magnet.

In the above embodiment, the electromagnetic actuator that avoids enlargement is used in a light-reducing filter actuator. However, the present invention is not limited in such a manner. For example, the electromagnetic actuator of the above embodiment may be applied to a light path switch mirror actuator (actuator for moving a movable mirror) arranged in a light path switching unit. This would ensure position detection of the movable mirror, improve the operational reliability, and avoid enlargement of the light path switching unit. Thus, when an optical pickup module incorporates such a light path switching unit, the operational reliability can be improved and enlargement of the optical pickup module can be avoided.

The application of the electromagnetic actuator according to the present invention is not limited to an optical pickup module. For example, the electromagnetic actuator may be applied to a drive mechanism for a precision apparatus such as a semiconductor manufacturing device, a liquid crystal manufacturing device, and a machining tool. This would ensure that the precision apparatus performs position detection and avoids enlargement of the precision apparatus.

The present examples and embodiments are to be considered as illustrative and not restrictive, and the invention is not to be limited to the details given herein, but may be modified within the scope and equivalence of the appended claims.

What is claimed is:

1. An electromagnetic actuator comprising:
a stationary portion on which a first position and a second position are defined;
a plurality of first electric wires arranged on the stationary portion at the first position and the second position;
a movable portion movable between the first position and the second position and including a magnetic pole surface having a magnetic pole, with the magnetic pole surface facing toward a corresponding one of the first electric wires when the movable portion is located at the first position or the second position; and
a drive circuit for moving the movable portion;
wherein the electromagnetic actuator uses electromagnetic induction that occurs due to each of the first electric wires and the magnetic pole to detect the position of the movable portion, and wherein when trying to move the movable portion to the first position, the drive circuit temporarily applies force to the movable portion to move the movable portion toward the second position.

2. The electromagnetic actuator according to claim 1, further comprising:
a plurality of second electric wires arranged in a line between the plurality of first electric wires in a manner facing toward the magnetic pole surface in the movable portion;
wherein the drive circuit supplies current to selected one or more of the second electric wires to generate a magnetic field with the selected one or more of the second electric wires and use attraction force or repulsion force acting between the magnetic field and the magnetic pole to move the movable portion along the line of the second electric wires.

3. The electromagnetic actuator according to claim 2, wherein when trying to move the movable portion to the first position, the drive circuit first supplies current to selected one or more of the second electric wires to move the movable portion toward the second position and then supplies current to selected one or more of the second electric wires to move the movable portion toward the first position.

4. The electromagnetic actuator according to claim 2, wherein when trying to move the movable portion to the first position, the drive circuit temporarily applies force to the movable portion to first move the movable portion toward the second position and away from the first position, and then supplies current to selected one or more of the second electric wires to move the movable portion to the first position and generate induced electromotive force with the first electric wire arranged at the first position.

5. The electromagnetic actuator according to claim 4, further comprising:
a detection circuit connected to the first electric wires to detect the position of the movable portion based on the induced electromotive force.

6. The electromagnetic actuator according to claim 2, wherein each of the first and second electric wires is a planar coil.
